(19) United States
(12) Patent Application Publication
(10) Pub. No.: US 2019/0330827 A1
(43) Pub. Date: Oct. 31, 2019

(54) CONTROL OF BATHING APPARATUS

(71) Applicant: Kohler Mira Limited, Gloucestershire (GB)

(72) Inventors: Christopher Laurence SEYMOUR, Gloucestershire (GB); Alexander Colin Fagg, Gloucestershire (GB); Richard Harcourt Burns, Gloucestershire (GB); Karl Antony Fearnley, Gloucestershire (GB); Christopher John Duke, Gloucestershire (GB)

(21) Appl. No.: 16/510,037

(22) Filed: Jul. 12, 2019

Related U.S. Application Data
(63) Continuation of application No. PCT/GB2018/050031, filed on Jan. 8, 2018.

(30) Foreign Application Priority Data
Jan. 13, 2017 (GB) 1700636.2

(51) Int. Cl. E03C 1/05; G05D 7/06; G06F 21/31; G06F 3/0484; H04L 12/28

(52) U.S. Cl. CPC E03C 1/055; G05D 7/0623; H04L 12/2818; G06F 3/04847; G06F 21/31

(57) ABSTRACT

A bathing system includes a remotely controllable bathing apparatus and one or more computing devices which are arranged to support a plurality of user accounts. Each user account is arranged to control the bathing apparatus. When a first user account of the plurality of user accounts is used to control the bathing apparatus, the other user accounts of the plurality of user accounts are blocked from controlling one or more functions of the bathing apparatus for a blocking period which lasts until a pre-set condition is met.

### CROSS-REFERENCE TO RELATED PATENT APPLICATIONS

The present application is a Continuation of International Application No. PCT/GB2018/050031, filed Jan. 8, 2018, which claim priority to and the benefit of United Kingdom Patent Application No. GB 1700636.2, filed Jan. 13, 2017. The entire disclosures of each of the foregoing applications are incorporated by reference herein.

This application is related to and incorporates by reference (but does not claim priority to) the following United Kingdom Patent Applications, each of which were filed on Jan. 13, 2017: GB 1700633.9; GB 1700631.3; and GB 1700630.5.

### BACKGROUND

The invention relates to control of a remotely controllable bathing apparatus. In particular, the invention relates to security of remote control, and more specifically to the management of potentially unwanted, conflicting and/or malicious control instructions.

In the prior art, a home automation system which can be controlled by a smartphone to control a shower or bath is known. In the example described in US 2016/335423 (A), users can be authorized, or otherwise, for providing a command. Different devices may be afforded different privileges or command functionality.

### SUMMARY

An exemplary embodiment relates to a bathing system that includes a remotely controllable bathing apparatus and one or more computing devices which are arranged to support a plurality of user accounts, each user account being arranged to control the bathing apparatus. When a first user account of the plurality of user accounts is used to control the bathing apparatus, the other user accounts of the plurality of user accounts are blocked from controlling one or more functions of the bathing apparatus for a blocking period which lasts until a pre-set condition is met, whereas the first user account is not blocked from controlling the one or more functions.

Another exemplary embodiment relates to a control system for a bathing apparatus that includes a plurality of user accounts, each user account being arranged to control the bathing apparatus, wherein, when a first user account of the plurality of user accounts is used to control the bathing apparatus, the other user accounts of the plurality of user accounts are blocked from controlling one or more functions of the bathing apparatus for a blocking period which lasts until a pre-set condition is met, whereas the first user account is not blocked from controlling the one or more functions.

Another exemplary embodiment relates to a computer application for controlling a bathing apparatus and arranged to be useable with a plurality of different user accounts. The application is arranged such that when a first user account of the plurality of user accounts is used to control the bathing apparatus via the application, the other user accounts of the plurality of user accounts are blocked, by the computer application, from controlling the bathing apparatus until a pre-set condition is met, whereas the first user account is not blocked from controlling the one or more functions.

Another exemplary embodiment relates to a computer-implemented method of controlling a bathing apparatus that includes configuring a plurality of user accounts such that each user account can be used to control the bathing apparatus, receiving bathing apparatus control instructions from a first user account of the plurality of user accounts, implementing the bathing apparatus control instructions from the first user account, and blocking bathing apparatus control instructions relating to one or more functions of the bathing apparatus from the other user accounts of the plurality of user accounts for a blocking period which lasts until a pre-set condition is met, whereas the first user account is not blocked from controlling the one or more functions.

### BRIEF DESCRIPTION OF THE DRAWINGS

There now follows by way of example only a detailed description of embodiments of the present invention with reference to the accompanying drawings in which:

FIG. 1 is a schematic representation of a controllable bathing system of an embodiment of the invention;

FIG. 2 is a flow chart illustrating the method of an embodiment; and

FIGS. 3A to 3D show schematic views of a computer application used to implement the method of FIG. 2.

### DETAILED DESCRIPTION

According to a first aspect of the invention, there is provided a bathing system comprising a remotely controllable bathing apparatus, and one or more computing devices. The computing devices are arranged to support a plurality of user accounts which are each arranged to control the bathing apparatus. When a first user account of the plurality of user accounts is used to control the bathing apparatus, the other user accounts of the plurality of user accounts are blocked from controlling one or more functions of the bathing apparatus until a pre-set condition is met.

Once a first user account has been used to control the bathing apparatus (for example, turning on a shower), the first user account may remain active or a user may log out. The initial use of the first user account to control the bathing apparatus initiates a blocking period during which instructions from other user accounts relating to the one or more functions of the bathing apparatus are blocked. Further instructions from the first user account are not blocked. The initial use of the first user account to control the bathing apparatus may trigger assessment of the pre-set condition. The blocking period continues until the pre-set condition is met. A subsequent bathing control instruction sent via the first user account may extend the blocking period; i.e. the pre-set condition may be updated or a different pre-set condition selected. Advantageously, other users are therefore prevented from interfering with the first user's bathing session.

The one or more computing devices may be or comprise a plurality of portable user devices. Each of the portable user devices may be arranged to control the bathing apparatus, and each portable user device may correspond to a user account of the plurality of user accounts. When a first user device of the plurality of user devices is used to control the bathing apparatus, the other user devices of the plurality of user devices are blocked from controlling the one or more functions of the bathing apparatus until a pre-set condition is met.

Optionally, a single computing device may support some or all of the plurality of user accounts.

The period for which other user devices/accounts are blocked from controlling the one or more functions of the bathing apparatus may be described as a blocking period. For clarity, in the case where the first user is not blocked and other users are, the blocking period may be referred to as the first user's blocking period.

According to a second aspect of the invention, there is provided a control system for a bathing apparatus. The control system comprises a plurality of user accounts, each user account being arranged to control the bathing apparatus. When a first user account of the plurality of user accounts is used to control the bathing apparatus, the other user accounts of the plurality of user accounts are blocked from controlling one or more functions of the bathing apparatus until a pre-set condition is met.

According to a third aspect of the invention, there is provided a computer-implemented method of controlling a bathing apparatus. The method comprises the steps of:

(i) configuring a plurality of user accounts such that each user account can be used to control the bathing apparatus;

(ii) receiving bathing apparatus control instructions from a first user account of the plurality of user accounts;

(iii) implementing the bathing apparatus control instructions from the first user account; and

(iv) blocking bathing apparatus control instructions relating to one or more functions of the bathing apparatus from the other user accounts of the plurality of user accounts until a pre-set condition is met.

The skilled person will appreciate that only a single user account may be configured according to step (i) initially, but that step (iv) has no effect until multiple devices have been configured according to step (i). Step (i) may therefore occur after steps (ii) and/or (iii) have been performed by an initial, single user account.

According to a fourth aspect of the invention, there is provided a computer-implemented method of controlling a bathing apparatus. The method comprises the steps of:

(i) configuring a plurality of user accounts such that each user account can be used to control the bathing apparatus;

(ii) receiving first bathing apparatus control instructions from a first user account of the plurality of user accounts;

(iii) subsequently receiving, before a pre-set condition is met, second bathing apparatus control instructions from a second user account of the plurality of user accounts relating to one or more functions of the bathing apparatus; and

(iv) blocking the second bathing apparatus control instructions relating to the one or more functions of the bathing apparatus.

The method may further comprise implementing the bathing apparatus control instructions from the first user account. The implementation may be performed separately from the other steps, optionally by a separate device or processor.

According to a fifth aspect of the invention, there is provided a computer application for controlling a bathing apparatus. The computer application is arranged to be useable with a plurality of different user accounts. The application is arranged such that when a first user account of the plurality of user accounts is used to control the bathing apparatus via the application, the other user accounts of the plurality of user accounts are blocked, by the computer application, from controlling the bathing apparatus until a pre-set condition is met.

Optionally, the computer application may be arranged to be installed on a plurality of portable user devices, each portable user device corresponding to a user account of the plurality of user accounts. The application may be arranged such that when a first user device of the plurality of user devices is used to control the bathing apparatus via the application, the other user devices of the plurality of user devices are blocked, by the computer application, from controlling the bathing apparatus until the pre-set condition is met.

The pre-set condition may be the expiry of a set time period measured from a trigger event.

Examples of trigger events are:

(i) a particular action of the first user;

(ii) expiry of a bathing control instruction given by the first user;

(iii) an initial use of the first user account to control the bathing apparatus; and

(iv) a most recent use of the first user account to control the bathing apparatus.

In the bathing system, control system, computer application or method of any aspect of the invention, the pre-set condition may be one of the following:

(i) the expiry of a set time period from the first user account being used to control the bathing apparatus; or

(ii) receipt of data indicating that a bathing session has ended, for example the first user logging out or selecting an option or pressing a button to indicate that the bathing session has ended.

The length of the set time period may depend on the trigger event, for example being shorter when the trigger event is receipt of data indicating that a bathing session has ended than for a new bathing control instruction.

The pre-set condition may be the expiry of a set time period from the first user account being used to control the bathing apparatus, unless data is received indicating that a bathing session has ended before expiry of the set time period.

In embodiments wherein set time periods are used, a different duration may be selected for the set time period depending on parameters such as the type or content of bathing apparatus control instructions sent from the first user account, the identity of the first user account, and/or time of day.

Each user account may be associated with a portable user device, for example a smartphone, tablet, laptop, smartwatch or the likes.

The portable user devices may control the bathing apparatus via a computer application. The portable user devices may be able to control the bathing apparatus remotely.

A second user account of the plurality of user accounts which attempts to control the bathing apparatus but is blocked may receive an indication that the bathing apparatus is in use, for example an explanatory error message, a flashing light, a sound or a graphic.

The plurality of user accounts may include an administrator account with the ability to override the block. Bathing apparatus control instructions from the administrator account may be implemented irrespective of other user activity.

Bathing apparatus controls located on the bathing apparatus may be used to control the bathing apparatus, irrespective of user account activity. The bathing apparatus controls may be manual controls.

The method as described herein may further comprise securely pairing a device associated with each of, some of, or all of the user accounts with the bathing apparatus before that device can be used to control one or more functions of the bathing apparatus. Pairing may be performed by activating a pairing interface whilst the device is within a pairing region. The requirement for activation of an interface separate from the device whilst the device is within a pairing region may reduce or prohibit unauthorised users' access to the one or more functions of the bathing apparatus. The pairing interface may be, for example, a button in the same room as the bathing apparatus. The pairing region may be, for example, defined by an area in which a signal can be exchanged between the device and a pairing station. The content of applicant's corresponding United Kingdom Patent Application No. GB 1700633.9, entitled “BATHING CONTROL SECURITY” and filed on Jan. 13, 2017, is incorporated herein by reference, and provides further details of how the pairing may be performed.

In the bathing system, control system, computer application or method of any aspect of the invention, the one or more functions of the bathing apparatus that are blocked to other user accounts as a result of activity on the first user account may be:

(i) all functions of the bathing apparatus; or

(ii) a subset of functions of the bathing apparatus.

The skilled person would understand that features described with respect to one aspect of the invention may be applied, mutatis mutandis, to the other aspect of the invention.

In the Figures, like reference numerals are used for like components.

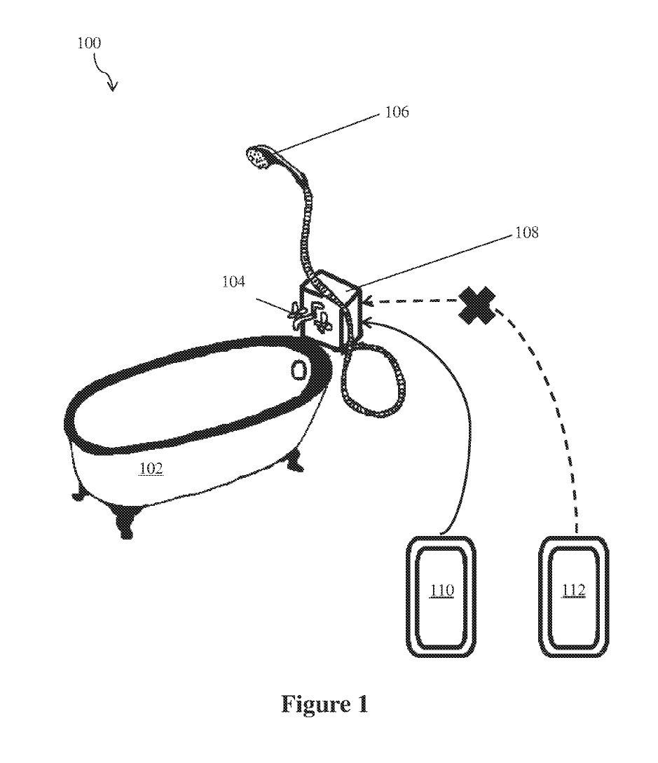

FIG. 1 shows a controllable bathing system 100. The controllable bathing system 100 comprises a bath tub 102, a mixer tap 104 and a shower 106.

In alternative or additional embodiments, the bathing system 100 may comprise a sink, a dual outlet shower, a bidet, no shower 106, separate taps instead of the mixer tap 104, and/or no bath tub 102. The skilled person will appreciate that the following description can be applied to any bathing apparatus 100 and is not limited to the example shown.

FIG. 1 shows two user devices 110, 112 and a bathing apparatus control system 108. The user devices 110, 112 are portable user devices, and more specifically smartphones in the embodiment being described. In alternative or additional embodiments, the user devices may be laptop or desktop computers, tablets, smart watches, dedicated remote control devices, or the likes.

The user devices 110, 112 are arranged to be able to communicate with the control system 108 so as to send bathing apparatus control instructions to the control system 108. The bathing apparatus control instructions are sent wirelessly, and more specifically via Bluetooth®, in the embodiment being described. In alternative embodiments, other means of communication may be used.

The control system 108 is arranged to initiate a response in line with the control instructions, for example running a bath to a specified depth and temperature or switching on the shower 106. A response is initiated unless instructions from the user device 110, 112 do not have the authorisation to have that instruction initiated, for example due to the instruction being blocked, or if the instructions violate safety limits (e.g. temperature above a set threshold) or comfort limits (e.g. temperature below a set threshold).

In the embodiment being described, the control system 108 is arranged to provide an indication that the user device 110, 112 lacks the authorisation to have that instruction initiated if that is the case. In particular, the control system 108 initiates the display of an alert on the screen of the user device 110, 112, informing the user that the instruction was blocked, and why. In alternative or additional embodiments, an audible alert, vibration, or a different visual alert may be used.

In the embodiment being described, each user device 110, 112 is used by a different user. Each user can log into his or her user account, and has that user account active on his or her device 110, 112. In alternative or additional embodiments, more than one user may use the same device 110, 112, each user having his or her own account which can be accessed on that device.

Bathing control instructions are sent via the user account. In this way, a given user can log into his or her user account on any device, for example using a set user name and password. In alternative embodiments, a user account may be defined differently—for example, each user device 110, 112 may constitute a user account, with details of the device 110, 112 (e.g. a serial number) replacing username and password identifiers.

A first user uses a first user device 110 of the user devices 110, 112. When the first user is logged into his or her user account on the first user device 110, bathing control instructions can be sent to the control system 108 from the first user device 110. The control system 108 implements the bathing control instructions. For a set time period, the control system 108 blocks any instructions from other user accounts/devices so as to allow the first user to retain control of the bathing apparatus 100 and prevent interference with that user's settings. The period during which any instructions from other user accounts/devices are blocked may be referred to as the first user's blocking period.

In the embodiment being described, the set time period for a shower is 10 minutes, or until the first user indicates via the user account that she or he has finished if that is shorter. In the embodiment being described, the set time period for a bath is 45 minutes, or until the first user indicates via the user account that she or he has finished if that is shorter. In alternative or additional embodiments, a different time period may be used, for example 2 minutes, 5 minutes, 15 minutes, 30 minutes or 1 hour, and/or the same or different time periods may be used depending on the instructions. Additionally or alternatively, the first user may be able to specify a minimum time period via the user account. In additional or alternative embodiments, no time period may be set—the blocking of other user accounts may finish when, for example, the first user logs out of the first user account or indicates via the first user account, or via a separate interface such as a button on a manual shower or bath control interface, that s/he has finished, or be triggered by an action or control instruction such as draining the bath 102 or turning off the shower 106.

In the embodiment being described, the set time period is initiated by sending the bathing control instructions. If further bathing control instructions are sent during the set time period, a new set time period is initiated, replacing the first. The new set time period may have a different duration, depending on the control instructions. For example, if a user initially requests a shower, initiating a 10 minute set period, but then has a change of heart and starts running a bath, a new, longer set time period of 45 minutes is initiated, in the embodiment being described. If, 25 minutes into the 45 minute period, the user pulls the plug of the bath, the remaining time of the set time period is reduced to a set level of 5 minutes, to allow time for the bath to drain and the user to get changed. The skilled person will appreciate that the times listed are provided by way of example only and are in no way limiting. In the embodiment being described, default time periods are pre-set but a user has the option of customizing these.

In alternative or additional embodiments, in cases where a user has specified a duration as part of the bathing control instructions (e.g. shower on for 10 minutes at 42° C.), the blocking of other user accounts may finish a set period after the specified duration; i.e. the set time period may be initiated by the expiry of the action relating to the instructions, or the expiry of a time period specified in the instructions.

Any action, condition or event which results in the set time period being reassessed may be referred to as a trigger event. As described above, in the embodiment being described, trigger events include, but are not limited to, actions of the first user, and different trigger events are handled differently in terms of the resultant length of the set time period.

In the embodiment being described, if a second user attempts to send bathing control instructions via a second user account, for example from the second user device 112, during the set time period, those instructions are blocked. The second user receives a message indicating that the bathing apparatus 100 is in use.

Any instructions sent via the second user account after the set time period has expired are implemented by the control system 108.

In the embodiment being described, manual controls for the bathing apparatus 100 are provided on or near the bathing apparatus 100 and use of these controls overrides any instructions sent via the user accounts. In alternative embodiments, no manual controls may be provided, or instructions sent via the user accounts may not be overridden by the manual controls.

In the embodiment being described, during the first user's blocking period the second user cannot control any functions of the bathing apparatus 100 via his or her user account, i.e. all instructions sent from the second user device 112 are blocked. In alternative embodiments, only a subset of instructions may be blocked—for example increasing water temperature and increasing water flow. In such embodiments, a subset of instructions may remain accessible—for example, reducing water temperature or water flow rate. This may be provided as a safety feature to reduce the chance of accidental scalding or overflow.

In the embodiment being described, a user account is defined as the master/administrator user account and instructions sent via that user account can override the block, i.e. any instructions from that account are implemented even during the blocking period.

In alternative or additional embodiments, different user accounts may have different permissions levels; for example, child and parent accounts, with parent accounts having the ability to override instructions sent from child accounts, and/or to specify limits on the instructions the child accounts can send.

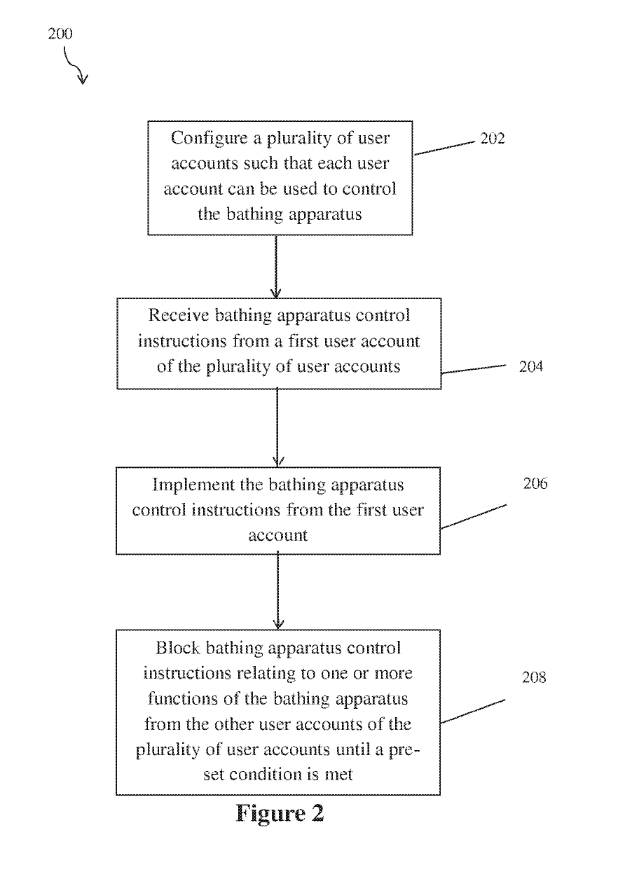

FIG. 2 provides a flow chart showing the method 200 described herein.

At step 202, a plurality of user accounts are configured such that each user account can be used to control the bathing apparatus 100. Each user account is accessed on a separate user device 110, 112 in the non-limiting embodiment described herein—the user devices 110, 112 may therefore be effectively equated to user accounts in this embodiment. The skilled person will appreciate that additional user accounts may be added later, for example after some or all of the following steps have been performed.

At step 204, bathing apparatus control instructions are received at the control system 108 from a first user account 110 of the plurality of user accounts. In alternative or additional embodiments, the bathing apparatus control instructions may not be sent directly to the control system 108, but may instead be sent to a processor separate from the control system 108 which responds accordingly and sends the bathing apparatus control instructions on to the control system 108 only if they are not blocked or otherwise refused.

At step 206, the bathing apparatus control instructions sent from the first user account 110 are implemented. In the embodiment being described, implementing the bathing apparatus control instructions can include turning the shower 106 or one or more taps 104 on or off, or otherwise adjusting the flow rate and/or temperature, or opening a drain (e.g. by raising a plug, not shown).

At step 208, bathing apparatus control instructions relating to one or more functions of the bathing apparatus sent from any other user account of the plurality of user accounts are blocked until a pre-set condition is met. In the embodiment described above, the pre-set condition is expiry of a set time period, unless the first user indicates that the bathing session has ended before that. The person skilled in the art will appreciate that various alternative or additional pre-set conditions may be used.

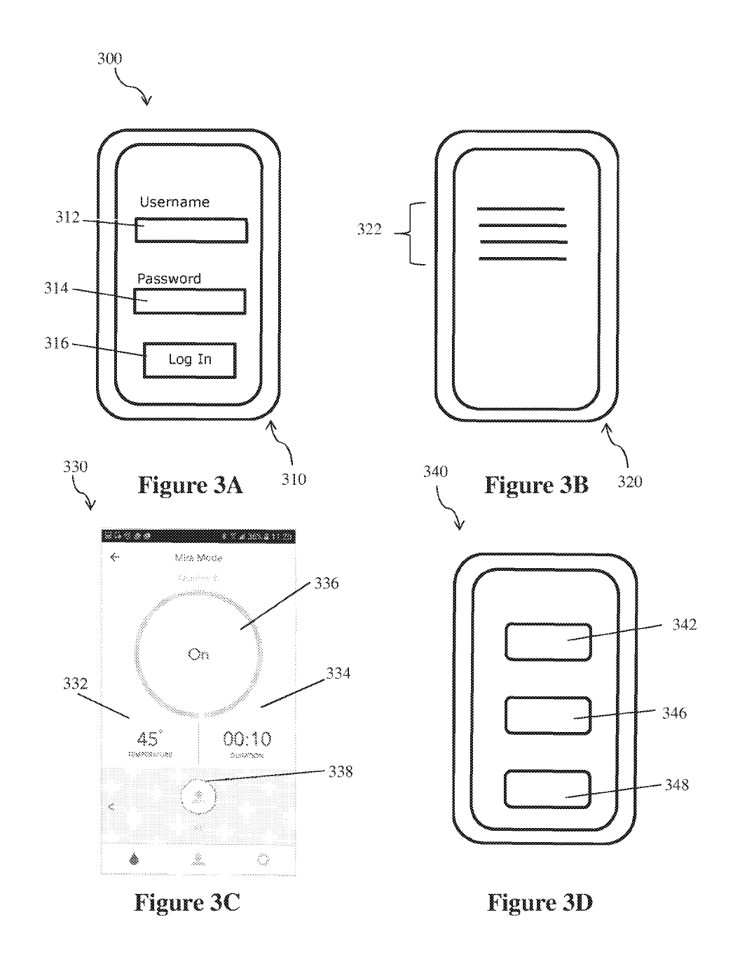

FIGS. 3A to 3D show a selection of screenshots 300 from a schematic example of a computer application for use with a touch screen device 110, 112.

The computer application is arranged to allow a user to control the bathing apparatus 100 via a user device 110, 112 on which the application is installed. The application is arranged to allow a user to raise or lower water temperature and raise or lower flow rate through any one or more selected outlets, such as the shower 106 and/or one or more taps 104.

In addition to allow a user to control the bathing apparatus 100, the application is also arranged to allow a user to customise his or her account. For example, a background image and user icon may be selected and used, and/or a “favourites” page may be provided for a user's most commonly-used options. In the embodiment being described, the application is also arranged to allow a user to save particular settings (e.g. desired shower temperature and duration, or desired bath depth and temperature) for future use. Default options may also be provided in at least some embodiments, and may be editable to allow adjustment to user preferences. The saved settings can then be selected and implemented automatically.

In the embodiment being described, any user can customize his or her user account, or enter information on particular settings for future use at any point, whether or not the bathing apparatus 100 is in use. In alternative or additional embodiments, some options not directly linked to bathing apparatus control instructions may also be blocked whilst the bathing apparatus 100 is in use. For example, in systems implementing the invention of the applicant's corresponding United Kingdom Patent Application No. GB 1700631.3, entitled, “BATH FILLING” and filed on Jan. 13, 2017, the contents of which are hereby incorporated by reference, options related to learning a user's preferences from bath usage may be blocked whilst a different user is using the bathing apparatus 100.

In the embodiment being described, the application offers the ability to control multiple different bathing apparatuses 100 with the same user account.

A first screenshot 310 shows a bathing control application log-in page 310. The page 310 has a username box 312 into which a user can enter a username associated with his or her user account and a password box 314 into which a user can enter a password associated with his or her user account. A log-in button 316 is also provided. Selecting the log-in button 316 once the username and password information has been correctly entered logs the device 110, 112 into the user account.

In alternative or additional embodiments, one or more additional buttons may be provided, for example a “Register” button for new users, a “Help” button, “Return to Main Menu” button, or the likes. Further, alternative interface designs may be used.

Once logged in, a menu screen 320 is displayed, showing a range of options 322 selectable by a user.

When an option is selected, a new option screen 330 is displayed. In the example shown, the option selected was a pre-defined shower. The option screen 330 indicates the pre-defined temperature 332 (in this case, 45° C.) and pre-defined duration 334 (in this case, 10 minutes) of the shower and provides an “On” button 336. When the “On” button 336 is selected, the bathing control instructions are sent from the user device 110, 112 and the bathing apparatus 100 is controlled accordingly unless the instructions are blocked. Option screen 330 also shows an icon 338. In the embodiment being described, the icon 338 is associated with the pre-defined shower and also appears next to the corresponding option in the range of options 322 on the menu screen 320. The icon 338 serves to allow a user to more easily identify the pre-defined options 322.

Once the “On” button 336 is selected, a new screen 340 is displayed. The screen 340 has three buttons; a “Finished” button 342, an “Edit Settings” button 344 and a “Log out” button 346.

In the embodiment being described, selecting the “Finished” button 342 terminates the shower even if the pre-defined duration has not expired, and returns the user to the menu screen 320. Selecting the “Log out” button 346 closes the application but leaves the shower running until the pre-defined duration expires. In alternative embodiments, selecting the “Log out” button 346 may also terminate the shower.

In the embodiment being described, selecting the “On” button 336 starts a pre-set time period during which instructions from other user devices 110, 112 are blocked. The blocking ends when the pre-set time period ends, unless further user instructions which extend the blocking period are received from the first user account during the blocking period.

In alternative or additional embodiments, selecting the “Finished” button 342 and/or selecting the “Log out” button 346 initiates a pre-set time period following the selection during which instructions from other user accounts are blocked. The blocking ends when the pre-set time period ends. In some cases, the pre-set time period may be zero, i.e. the blocking may end immediately when the “Finished” button 342 and/or the “Log out” button 346 is selected. In these embodiments, data entered via the user account is used to indicate that a bathing session has ended, and thereby to determine when to end the blocking.

In alternative or additional embodiments, user input indicating that the bathing session has ended may be received by a different means, for example by pressing a button located on manual controls of the bathing apparatus, or pulling the plug (in the case of a bath, in particular). This input may be used to determine when to end the blocking in the same way as for the “Finished” button 342 and/or the “Log out” button 346 input, described above.

Selecting the “Edit Settings” button 344 allows the user to increase or decrease the flow rate, temperature and/or duration of the shower, or to select another pre-defined option. Changing duration or selecting another pre-defined option can change the pre-set condition.

In the embodiment being described, if a second user sends bathing control instructions which are blocked, the second user device 112, via which the instructions are sent, displays an error message indicating that the bathing apparatus 100 is in use. Depending on user account settings, the second user may receive an alert indicating that the bathing apparatus 100 is available for use once the blocking period has expired.

In alternative or additional embodiments, the second user's instructions may be entered into a queue, and the bathing apparatus 100 may be reserved for the second user once the first user's bathing session has ended. Reservation may be achieved by accepting instructions from the second user device 112 and blocking any instructions from user accounts not belonging to the second user once the first user's blocking period has expired. In such embodiments, when the first user's blocking period has expired, the second user receives an alert indicating that the bathing apparatus 100 is now available and requesting an indication as to whether or not the queued instructions should be implemented.

The skilled person will appreciate that these screenshots 300 are provided by way of example only and are in no way intended to limit the invention to the particular presentation and/or content shown. In particular, fewer, more or different user options may be presented, the interface may have a different layout and/or control means (for example, a keyboard and/or mouse instead of a touch screen), and different text and/or graphics may be used.

The applicant's corresponding United Kingdom Patent Application No. GB 1700630.5, entitled “MULTIPLE OUTLET SHOWER CONTROL” and filed on Jan. 13, 2017, the contents of which are hereby incorporated by reference, provides further details of optional features and functions of the computer application described herein.

What is claimed is:

1. A bathing system comprising:
a remotely controllable bathing apparatus; and
one or more computing devices which are arranged to support a plurality of user accounts, each user account being arranged to control the bathing apparatus;
wherein, when a first user account of the plurality of user accounts is used to control the bathing apparatus, the other user accounts of the plurality of user accounts are blocked from controlling one or more functions of the bathing apparatus for a blocking period which lasts until a pre-set condition is met, whereas the first user account is not blocked from controlling the one or more functions.

2. The bathing system of claim 1, wherein:
the one or more computing devices are a plurality of portable user devices, each arranged to control the bathing apparatus, each portable user device corresponding to a user account of the plurality of user accounts; and
when a first user device of the plurality of user devices is used to control the bathing apparatus, the other user devices of the plurality of user devices are blocked from controlling the one or more functions of the bathing apparatus until a pre-set condition is met.

3. The bathing system of claim 1, wherein the pre-set condition is the expiry of a set time period measured from a trigger event.

4. The bathing system of claim 3, wherein the trigger event is:
(i) a particular action of the first user;
(ii) expiry of a bathing control instruction given by the first user;
(iii) an initial use of the first user account to control the bathing apparatus; or
(iv) a most recent use of the first user account to control the bathing apparatus.

5. The bathing system of claim 4, wherein the length of the set time period depends on the trigger event.

6. The bathing system of claim 4, wherein a different duration is selected for the set time period depending on parameters such as bathing apparatus control instructions sent from the first user account, the identity of the first user account, and/or time of day.

7. The bathing system of claim 4, wherein subsequent use of the first user account to control the bathing apparatus before the pre-set condition is met can change the pre-set condition.

8. The bathing system of claim 1, wherein the pre-set condition is receipt of data indicating that a bathing session has ended, for example the first user logging out or selecting an option to indicate that the bathing session has ended.

9. The bathing system of claim 1, wherein the pre-set condition is the expiry of a set time period from the first user account being used to control the bathing apparatus, unless data is received indicating that a bathing session has ended before expiry of the set time period.

10. The bathing system of claim 1, wherein each user account is associated with a portable user device.

11. The bathing system of claim 10, wherein the portable user devices are smartphones.

12. The bathing system of claim 10, wherein the portable user devices control the bathing apparatus via a computer application.

13. The bathing system of claim 10, wherein the portable user devices control the bathing apparatus remotely.

14. The bathing system of claim 1, wherein a second user account of the plurality of user accounts which attempts to control the bathing apparatus but is blocked receives an indication that the bathing apparatus is in use.

15. The bathing system of claim 1, wherein the one or more functions of the bathing apparatus that are blocked to other user accounts as a result of activity on the first user account are:
(i) all functions of the bathing apparatus; or
(ii) a subset of functions of the bathing apparatus.

16. A control system for a bathing apparatus comprising a plurality of user accounts, each user account being arranged to control the bathing apparatus, wherein, when a first user account of the plurality of user accounts is used to control the bathing apparatus, the other user accounts of the plurality of user accounts are blocked from controlling one or more functions of the bathing apparatus for a blocking period which lasts until a pre-set condition is met, whereas the first user account is not blocked from controlling the one or more functions.

17. A computer application for controlling a bathing apparatus and arranged to be useable with a plurality of different user accounts, wherein the application is arranged such that when a first user account of the plurality of user accounts is used to control the bathing apparatus via the application, the other user accounts of the plurality of user accounts are blocked, by the computer application, from controlling the bathing apparatus until a pre-set condition is met, whereas the first user account is not blocked from controlling the one or more functions.

18. The computer application of claim 17, wherein the computer application is arranged to be installed on a plurality of portable user devices, each portable user device corresponding to a user account of the plurality of user accounts, and wherein the application is arranged such that when a first user device of the plurality of user devices is used to control the bathing apparatus via the application, the other user devices of the plurality of user devices are blocked, by the computer application, from controlling the bathing apparatus until the pre-set condition is met.

19. A computer-implemented method of controlling a bathing apparatus comprising:
configuring a plurality of user accounts such that each user account can be used to control the bathing apparatus;
receiving bathing apparatus control instructions from a first user account of the plurality of user accounts;
implementing the bathing apparatus control instructions from the first user account; and
blocking bathing apparatus control instructions relating to one or more functions of the bathing apparatus from the other user accounts of the plurality of user accounts for a blocking period which lasts until a pre-set condition is met, whereas the first user account is not blocked from controlling the one or more functions.

20. The method of claim 19, further comprising securely pairing a device associated with each of, some of, or all of the user accounts with the bathing apparatus to enable it to be used to control the one or more functions of the bathing apparatus.
